(19) United States
(12) Patent Application Publication
(10) Pub. No.: US 2019/0249843 A1
(43) Pub. Date: Aug. 15, 2019

(54) LAMP AND VEHICLE LAMP

(71) Applicant: Koito Manufacturing Co., Ltd., Tokyo (JP)

(72) Inventors: Asami Sakashita, Shizuoka-shi (Shizuoka) (JP); Yuji Nakano, Shizuoka-shi (Shizuoka) (JP)

(21) Appl. No.: 16/258,774

(22) Filed: Jan. 28, 2019

(30) Foreign Application Priority Data
Feb. 9, 2018 (JP) 2018-021973

(51) Int. Cl. F21S 43/237; B60Q 1/34; F21S 43/245; F21S 43/14; F21S 43/247

(52) U.S. Cl. CPC F21S 43/237; B60Q 1/34; F21S 43/247; F21S 43/14; F21S 43/245

(57) ABSTRACT

A lamp includes a light source, a controller that controls an output of the light source, and a light emitting unit that reflects the light emitted from the light source one or more times and emits the reflected light. The light emitting unit includes an incident portion, a light guide path, a reflecting portion, and an emitting portion, and is configured to increase a light emitting area that emits light with brightness equal to or higher than an estimated value of the brightness in the emitting portion in accordance with an increase in the output of the light source.

### CROSS-REFERENCE TO RELATED APPLICATIONS

This application is based on and claims priority from Japanese Patent Application No. 2018-021973, filed on Feb. 9, 2018, with the Japan Patent Office, the disclosure of which is incorporated herein in its entirety by reference.

### TECHNICAL FIELD

The present disclosure relates to a lamp that is applicable to a vehicle or an illumination.

### BACKGROUND

As a vehicle lamp in the related art used for a tail lamp or a stop lamp, a vehicle lamp has been known that is configured to obtain a linear light emission by arranging a light source such as an LED at an end of a rod-shaped light guide body. Further, in recent years, in a turn signal lamp (direction indicator) of a vehicle, a technology that realizes a light emission with motion at a front surface portion of a light guide body has been also devised by turning ON a plurality of light sources in an order (consecutive type turning ON, sequential turning ON), instead of turning ON the plurality of light sources at the same time. See, e.g., Japanese Patent Laid-Open No. 2016-212988.

### SUMMARY

However, in the vehicle lamp described above, since the sequential light emission is realized by turning ON the plurality of LEDs in an order, the plurality of LEDs are required. Further, since a space for arranging the plurality of LEDs around the light guide body is required, the size of the vehicle lamp is increased.

The present disclosure has been made in consideration of the circumstances. The present disclosure is to provide an inventive technology of realizing a light emission with motion with a relatively small number of light sources.

In order to solve the above problems, a lamp according to an aspect of the present disclosure includes a light source, a controller that controls an output of the light source, and a light emitting unit that reflects the light emitted from the light source one or more times and emits the reflected light. The light emitting unit includes an incident portion to which the light emitted from the light source is incident, a light guide path through which the incident light travels in a direction away from the incident portion while being reflected, a reflecting portion that is formed on a rear surface side of the light guide path, and an emitting portion that is formed on a front surface side of the light guide path and from which a part of the light reflected by the reflecting portion is emitted. The light emitting unit is configured to increase a light emitting area that emits light with brightness equal to or higher than a predetermined value of the brightness in the emitting portion in accordance with an increase in the output of the light source.

According to the aspect, the light emitting area may be increased by increasing the output of the light source.

The light guide path may be configured to increase the light emitting area in a direction away from the incident portion in accordance with the increase in the output of the light source. Therefore, the light emitting unit seems to gradually extend the light emitting area in the direction away from the incident portion.

The light guide path may be a light guide body having a shape such that a part of the incident light is totally reflected by an inner surface of the emitting portion, and the reflecting portion may be a reflective film that covers a surface on a rear surface side of the light guide body. Therefore, light may be guided while being attenuated by reflection at the reflecting portion.

The light guide body may include a plurality of steps formed on a rear surface side thereof that reflect light guided inside the light guide body toward the emitting portion. Therefore, light may be reflected toward the emitting portion with a simple configuration.

Another aspect of the present disclosure is a vehicle lamp. The vehicle lamp includes the lamp described above. The lamp is arranged such that a length direction of the light emitting unit is in a vehicle width direction, and is arranged such that the incident portion is positioned at a center side of the vehicle among length direction opposite ends of the light emitting unit. Therefore, for example, the lamp may be used as a turn signal lamp of a consecutive type turning ON (sequential turning ON). Further, in order to realize the sequential turning ON, it is not required to arrange a plurality of light sources in a line-shape and individually control the turning ON, and it is sufficient to control an output of one or more light sources.

Any combination of the above-described constituent elements and those obtained by converting expressions of the present disclosure that are transformed among methods, apparatuses, and systems are also effective as aspects of the present disclosure.

According to the present disclosure, light emission with motion may be realized with a relatively small number of light sources.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a schematic configuration of a turn signal lamp according to the present embodiment.

FIG. 2 is a plan view schematically illustrating a main part including a light guide body of the lamp illustrated in FIG. 1.

FIG. 3 is a block diagram including a controller of a vehicle lamp according to the present embodiment.

FIG. 4 is a schematic view illustrating a light guiding state in the light guide body according to the present embodiment.

FIG. 5A is a schematic view illustrating a state of light guided inside the light guide body while being reflected by a reflective film, and FIG. 5B is a view illustrating a relationship between a light guiding distance and light amount.

FIGS. 6A to 6D are views for explaining sequential turning ON of the turn signal lamp.

FIG. 7 is a schematic view illustrating a variation of a light guide body.

### DETAILED DESCRIPTION

Hereinafter, embodiments of the present disclosure will be described with reference to the drawings. Identical or corresponding components, members, and processes in each of the drawings will be denoted by the same symbols, and overlapping descriptions thereof will be appropriately omitted. Further, the embodiments are not intended to limit the present disclosure thereto, but are merely exemplary. All features described in the embodiments or combinations thereof may not be essential for the present disclosure.

The present disclosure may be applied to various kinds of lamps, for example, to a vehicle lamp. Examples of a vehicle lamp may include various lamps such as a head lamp, a tail lamp, a clearance lamp, a turn signal lamp, a stop lamp, a daytime running lamp, a cornering lamp, a hazard lamp, a position lamp, a back lamp, and a fog lamp, or various combination lamps in which functions of two or more kinds of lamps among these lamps are combined. In the following description, a case where the present disclosure is applied to a turn signal lamp which is one of vehicle lamps will be described.

(Vehicle Lamp)

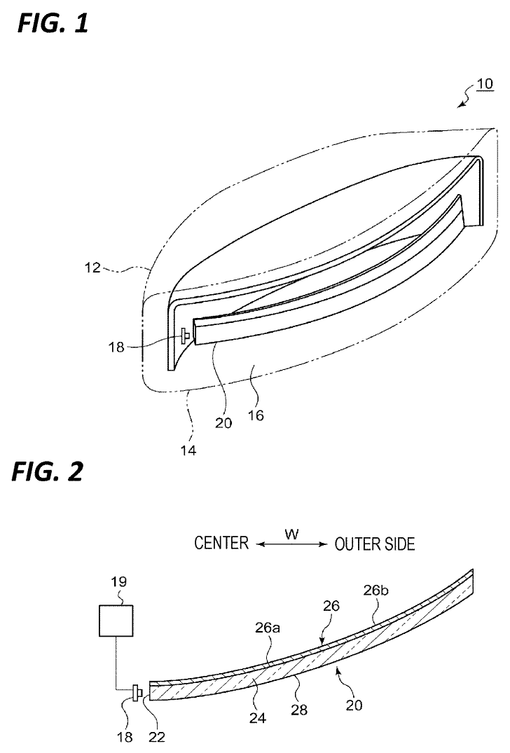

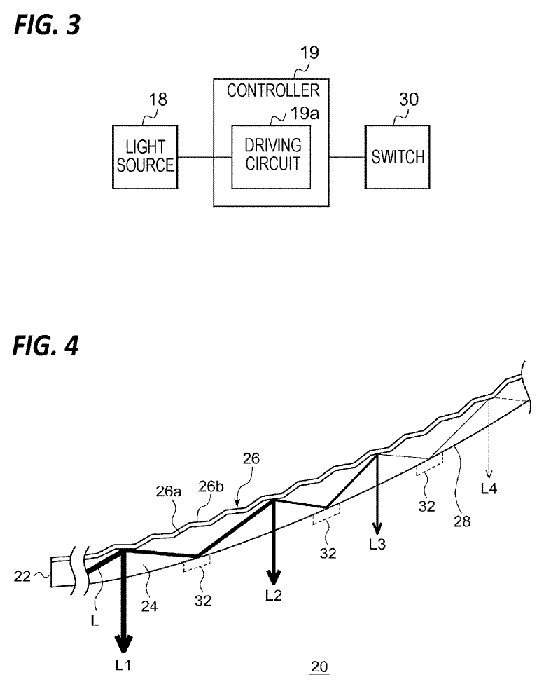

A vehicle lamp according to the present embodiment is a turn signal lamp provided at a right side rear end portion of a vehicle body. FIG. 1 is a perspective view illustrating a schematic configuration of the turn signal lamp according to the present embodiment. FIG. 2 is a plan view schematically illustrating a main part including a light guide body of the lamp illustrated in FIG. 1. FIG. 3 is a block diagram including a controller of a vehicle lamp according to the present embodiment. FIG. 4 is a schematic view illustrating a light guiding state in the light guide body according to the present embodiment.

The vehicle lamp 10 illustrated in FIG. 1 includes a lamp housing 12 having a recess that is opened forward, and a transparent cover 14 blocking the opening of the lamp housing 12. In the vehicle lamp 10, an inner space partitioned by the lamp housing 12 and the cover 14 is formed as a lamp chamber 16.

In the lamp chamber 16, a light source 18, and a light guide body 20 as a light emitting unit that reflects light emitted from the light source 18 one or more times at inside thereof and emits the reflected light are arranged. Examples of the light source 18 include a semiconductor light emitting element such as an LED, an LD, and EL. Further, the vehicle lamp 10 includes a controller 19 that controls an output of the light source 18, and a switch 30 configured to operate a direction indicator.

The light guide body 20 includes an incident portion 22 to which the light emitted from the light source 18 is incident, a light guide path 24 through which the incident light travels in a direction away from the incident portion 22 while being reflected, a reflecting portion 26 that is formed on a rear surface side of the light guide path 24, and an emitting portion 28 that is formed on a front surface side of the light guide path 24 and from which a part of the light reflected by the reflecting portion 26 is emitted.

The light guide body 20 is arranged such that a length direction thereof is along a vehicle width direction W, and is also arranged such that the incident portion 20 is positioned at a center side of the vehicle among length direction opposite ends. Further, the light guide body 20 is a transparent member (light transmittance of 50% or more) with respect to the light emitted from the light source 18, and is made of polycarbonate resin, methacrylic resin, acrylic resin, glass, or the like.

The reflecting portion 26 includes a plurality of reflective steps 26a (see, e.g., FIG. 4) formed on a rear surface of the light guide path 24. A reflective step 26a has a shape that reflects a part of the light guided through the light guide path 24 toward the emitting portion 28 so as to be emitted from the emitting portion to the front of the lamp. Therefore, the reflecting portion 26 may reflect the light toward the emitting portion 28 with a simple configuration.

In a general light guide body, light travels through inside the light guide body using total reflection by an inner surface of the light guide body. Reflectance of light by total reflection is ideally 100% (excluding absorption by a substance), and light is not attenuated even when reflection is repeated. Therefore, brightness in a length direction of an emitting portion becomes uniform, and even when an output of a light source is changed, only the brightness of the entire emitting portion is changed uniformly, and it is hard to say that change is light emission with motion (change in light emission area).

Therefore, the reflecting portion 26 according to the present embodiment has a reflective film 26b that covers a surface of the reflective step 26a. Unlike the total reflection, the reflectance of the reflection by the reflective film 26b is less than 100%. For example, in a case of a metal deposited reflective film in which aluminum is deposited on the surface of the reflective step 26a, the reflectance is approximately 85%, and the light amount is attenuated to 85% by one reflection. That is, the light guide body 20 may guide light while attenuating the light by reflection at the reflecting portion 26. Meanwhile, the light guide body has a shape such that a part of the incident light is totally reflected by the inner surface of the emitting portion 28. That is, the light incident to the light guide body 20 is not attenuated by the reflection by the inner surface of the emitting portion 28.

Therefore, as illustrated in FIG. 4, light L1 emitted from the emitting portion 28 by reflecting light L once by the reflective step 26a has light amount of L1=L×(0.85)¹=0.85 L. Similarly, light L2 emitted from the emitting portion 28 by reflecting the light L twice by the reflective steps 26a has light amount of L2=L×(0.85)²≈0.72, and light L3 emitted from the emitting portion 28 by reflecting the light L three times by the reflective steps 26a has light amount of L3=L×(0.85)³≈0.61, light L4 emitted from the emitting portion 28 by reflecting the light L four times by the reflective steps 26a has light amount of L4=L×(0.85)⁴≈0.52.

In this manner, by using the reflective film 26b as a reflecting portion, the brightness of the emitting portion 28 of the light guide body 20 may be made relatively darker as the distance from the incident portion 22 increases. The reflective film is not limited to aluminum, and may be other metal films or a coating film having relatively low reflectance.

As a result of intensive studies based on the above findings, the present inventors has reached an aspect in that, by controlling the output of the light source, it is possible to realize light emission with motion in the emitting portion of the light guide body.

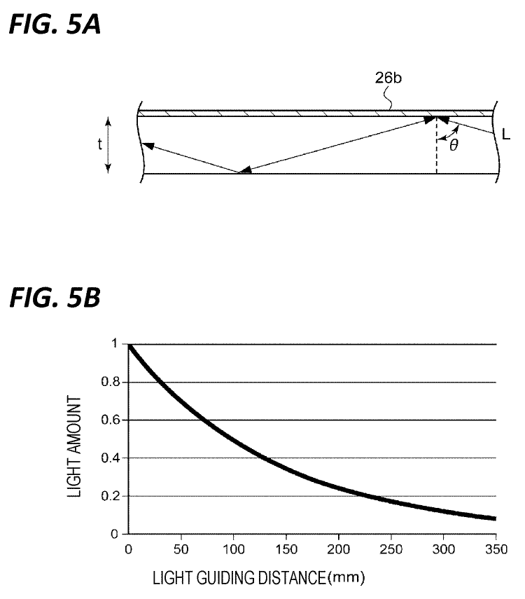

FIG. 5A is a schematic view illustrating a state of light guided inside the light guide body while being reflected by a reflective film, and FIG. 5B is a view illustrating a relationship between a light guiding distance and light amount. The light guide body illustrate in FIG. 5A has a thickness t of 4 mm, and the reflective film 26b is formed on a rear surface side thereof. Light L whose incident angle θ is 80° is incident to the light guide body. As a result, as illustrated in FIG. 5B, the light amount of the light L is gradually decreased in accordance with an increase of the light guiding distance.

In the light guide body illustrated in FIG. 5A, the light amount at a light guiding distance of 100 mm becomes approximately half of the light amount at a light guiding distance of 0 mm Therefore, assuming that a minimum current for turning ON the light source 18 is I, when current 21 that is double the current I is applied to the light source, the light amount at the light guiding distance of 100 mm may be equal to the light amount at the light guiding distance of 0 mm when the light source is turned ON with the minimum current I. In that case, the light emitting unit which appears brightly only in the vicinity of the incident portion in a state where the light source 18 is turned ON with the minimum current I appears brightly up to the range of 100 mm from the incident portion.

Therefore, by controlling the output of the light source 18 with a driving circuit 19a provided in the controller 19, a size of the light emitting area that emits light with the brightness equal to or higher than a predetermined value may be changed in the emitting portion. Therefore, by using such a phenomenon, the turn signal lamp may be turned ON sequentially.

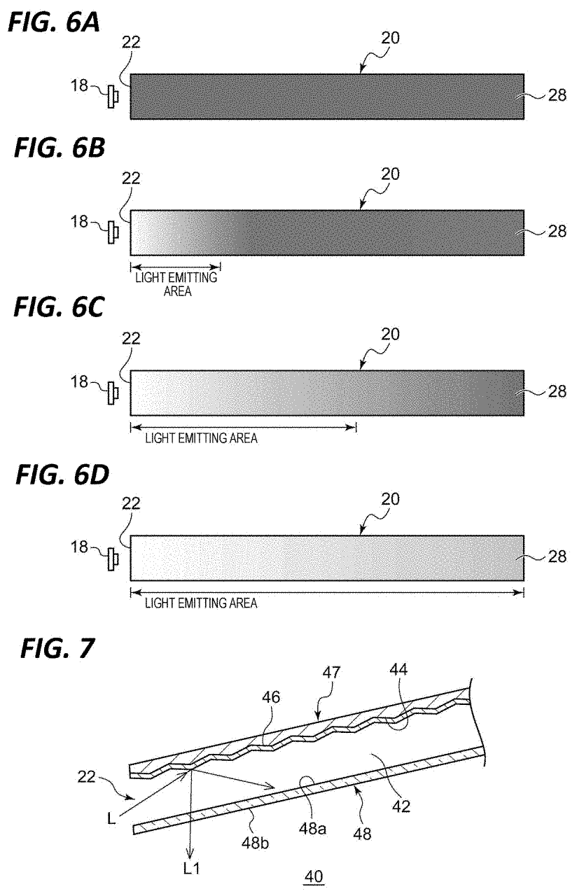

FIGS. 6A to 6D are views for explaining sequential turning ON of the turn signal lamp.

As illustrated in FIG. 6A, in a state where the light source 18 is not driven, the entire surface of the emitting portion 28 of the light guide body 20 is turned OFF. Next, when a driver operates the switch 30 that operates the turn signal lamp illustrated in FIG. 3, the driving circuit 19a causes to apply the current that is double the minimum current I to the light source 18. Therefore, immediately after operating the switch 30, as illustrated in FIG. 6B, the emitting portion 28 of the light guide body 20 emits light with brightness equal to or higher than a predetermined value in the range of 100 mm from the incident portion 22.

Next, when the controller 19 gradually increases the amount of current that is applied to the light source 18 by the driving circuit 19a, in accordance with the increase of the output of the light source 18, the light emitting area that emits light with the brightness equal to or higher than the predetermined value is increased in the emitting portion 28 (see, e.g., FIG. 6C). Then, when the amount of the current is increased up to 121, the entire surface of the emitting portion 28 becomes bright (FIG. 6D). In this manner, the light guide body 20 is configured such that the light emitting area is increased in a direction away from the incident portion 22 in accordance with the increase in the output of the light source 18. Therefore, the vehicle lamp 10 seems to gradually extend the light emitting area in the direction away from the incident portion, and thus, the sequential turning ON may be realized. Further, in the vehicle lamp 10, in order to realize the sequential turning ON, it is not required to arrange a plurality of light sources in a line-shape and individually control the turning ON, and it is sufficient to control the output of one or more light sources 18.

In the above description, the inner reflection of the emitting portion 28 of the light guide body 20 is described as total reflection, but, for example, a reflective film 32 may be provided at a position where light (e.g., L1 to L4) emitted from the emitting portion 28 is not shielded as much as possible. Therefore, the attenuation of the light guided through the light guide path 24 may be enhanced.

The light guide path 24 according to the present embodiment is a rod-shaped member such as a solid prismatic column or a cylinder, and is curved according to the appearance design of the vehicle, but the light guide path 24 is not necessarily solid, but may be hollow. FIG. 7 is a schematic view illustrating a variation of a light guide body. A light guide body 40 according to the variation is constituted of a reflecting mirror 47 to which a reflective film 46 such as a metal film is formed, and a transparent member 48 such as an inner lens provided so as to face the reflecting mirror 47. A region between the reflecting mirror 47 and the transparent member 48 functions as a light guide path 42. A plurality of reflective steps 44 are formed on an inner wall of the reflecting mirror 47, and the reflective film 46 is formed to cover the reflective steps 44.

Further, in the transparent member 48, a metal film may be half-deposited on either a light incident surface 48a or a light emitting surface 48b. Therefore, the transparent member 48 may function as a half-mirror, reflect the light guided through the light guide path 42 and propagate the light to a further distance, and emit a part of the light from the light emitting surface 48b.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lamp comprising:
a light source;
a controller that controls an output of the light source; and
a light emitting unit that reflects the light emitted from the light source one or more times and emits the reflected light,
wherein the light emitting unit includes: an incident portion to which the light emitted from the light source is incident; a light guide path through which the incident light travels in a direction away from the incident portion while being reflected; a reflecting portion that is formed on a rear surface side of the light guide path; and an emitting portion that is formed on a front surface side of the light guide path and from which a part of the light reflected by the reflecting portion is emitted, and is configured to increase a light emitting area that emits light with brightness equal to or higher than an estimated value of the brightness in the emitting portion in accordance with an increase in the output of the light source.

2. The lamp of claim 1, wherein the light guide path is configured to increase the light emitting area in a direction away from the incident portion in accordance with the increase in the output of the light source.

3. The lamp of claim 1, wherein the light guide path is a light guide body having a shape such that a part of the incident light is totally reflected by an inner surface of the emitting portion, and the reflecting portion is a reflective film that covers a surface on a rear surface side of the light guide body.

4. The lamp of claim 2, wherein the light guide path is a light guide body having a shape such that a part of the incident light is totally reflected by an inner surface of the emitting portion, and the reflecting portion is a reflective film that covers a surface on a rear surface side of the light guide body.

5. The lamp of claim 3, wherein the light guide body includes a plurality of steps formed on a rear surface side thereof that reflect light guided inside the light guide body toward the emitting portion.

6. The lamp of claim 4, wherein the light guide body includes a plurality of steps formed on a rear surface side thereof that reflect light guided inside the light guide body toward the emitting portion.

7. A vehicle lamp comprising the lamp of claim 1,
wherein the lamp is arranged such that a length direction of the light emitting unit is in a vehicle width direction, and is arranged such that the incident portion is positioned at a center side of the vehicle among length direction opposite ends of the light emitting unit.
